(19) United States
(12) Patent Application Publication
(10) Pub. No.: US 2011/0087529 A1
(43) Pub. Date: Apr. 14, 2011

(54) METHODS AND SYSTEMS FOR CREATION AND DISTRIBUTION OF PROMOTIONAL MATERIALS AND GATHERING OF CONSUMER DATA

(76) Inventor: MATTHEW JASON ANGELL, KANSAS CITY, MO (US)

(21) Appl. No.: 12/578,920

(22) Filed: Oct. 14, 2009

(51) Int. Cl. G06Q 30/00; G06Q 10/00; H04W 4/12; G06F 17/00; H04B 5/00

(52) U.S. Cl. 705/14.13; 705/14.36; 705/14.38; 455/466; 235/375; 455/41.1

(57) ABSTRACT

A system and methods for the creation and/or distribution of promotional materials, such as coupons, to consumers is provided. A promotional material item is created electronically and a copy of the item is distributed to mobile devices, or other electronic devices, of consumers. Each copy of the promotional material item includes a unique identifier for redemption and tracking purposes.

### FIELD OF THE INVENTION

The present invention relates to the field of electronic publishing, promotion and consumer data acquisition. More specifically, the present invention is concerned with methods and systems for the creation and distribution of promotional materials, such as coupons. The present invention is also concerned with the gathering, tracking, or other acquisition of data regarding consumers that receive the promotional materials and/or data otherwise relating to the promotional materials.

### BACKGROUND OF THE INVENTION

U.S. Pat. No. 6,931,591 (the “'591 Patent”), the entire disclosure of which is incorporated herein by reference, discloses a publishing layout wizard that aids content providers, such as product manufacturers, to make and distribute advertising graphics, materials, layouts, templates and/or promotional specifications or rule sets to merchants, dealers or other distributors of the manufacturer's products for use in advertisement campaigns conducted by such merchants, dealers or distributors. The invention disclosed in the '591 Patent allows for the efficient and easy distribution of advertisement/promotional materials from manufacturers to merchants/dealers/distributors. Nevertheless, while the layout wizard of the '591 Patent could be capable of designing promotional materials, such as coupons, for use by merchants/dealers/distributors (and the like), it does not provide any mechanism for distributing coupons (or other promotional materials) to consumers.

As the internet has become more and more popular, many consumers look to the internet for product promotional materials such as coupons. Therefore, it is desirable to provide a method and system for the creation and distribution to consumers of promotional materials, such as coupons, through an electronic environment such as the internet, SMS (short message service) text, etc. Furthermore, while many coupons are currently available over the internet and/or in other electronic forms, current distribution systems require consumers to either print hard copies of the coupons or to use promotional codes from the coupons when purchasing products with the coupons. Such “electronic” coupons or promotion codes are generally “mass” discount materials, in that they do not allow manufacturers (or merchants/dealers/distributors/etc.) to control coupon consumption and/or track data regarding coupon usage/distribution/etc. on a individual (or individualized) basis. Therefore, it is desirable to provide a method and system for the creation and distribution of coupons to consumers that allows manufacturers (or other coupon distributors) to control coupon consumption and/or track coupon or consumer data on an individual or individualized basis.

### SUMMARY OF THE INVENTION

An object of the instant invention is to provide a system and methods for the creation and/or distribution of promotional materials, such as coupons, to consumers. Another object of the instant invention is to provide a system and methods for the distribution of promotional materials, such as coupons, through an electronic environment. Still another object of the instant invention is to provide a system and methods for the creation and/or distribution of coupons to consumers that allows manufacturers (or other coupon distributors) to control coupon consumption and/or track coupon or consumer data on an individual or individualized basis.

The objects of the instant invention are accomplished through the use of a system in which a manufacturer, brand owner, retailer, dealer, merchant or other coupon distributor creates a coupon (or other item of promotional material) in an electronic form, which is ultimately distributed to a mobile phone, PDA (personal data assistant), computer, or other electronic device of a consumer.

In one preferred embodiment, discussed herein, a template coupon (or other promotional material item) is created by a manufacturer (or brand owner, licensor, or “originator”/“distributor” of the coupon) utilizing a client/server based publishing layout wizard of the type described in the '591 Patent. The created coupon template is stored in an Offer database (or in a Template and Image Inventory database, or in a template portion of the Offer database) of or accessible by a System Server (as described in the '591 Patent) for access by local dealers, store owners etc. Once the template is created, it may be accessed and customized by local dealers, store owners, etc. that access the Offer database located on the server. The coupon is customized in the same or similar manner as described in the '591 Patent. It will be appreciated that alternative methods and systems for creating electronic coupons may be utilized without departing from the spirit and scope of the instant invention. It will further be appreciated that, although creation of a coupon is described herein in a preferred embodiment, any item promotional material item may be utilized in connection with the instant invention.

The template includes one or more products which may be selected by the local dealer that is customizing the coupon. If provided by the manufacturer, the coupon template also includes details regarding one or more offers that may be provided in the coupon, such as the terms of a discount or other arbitrary math (i.e. buy one get on free, etc.) that is being provided through the coupon. The local dealer that is customizing the coupon selects the product and the offer to provide, or otherwise designs its own offer/coupon pursuant to whatever rules/guidelines are required by the manufacturer through the template. The SKU (stock-keeping unit), or other product/service identifier, for the product/service to which the coupon relates is embedded in the saved template for inclusion in the final customized coupon. Once completed, the customized coupon is stored on the System Server (or in a database accessible by the System Server, such as the Offer database, template database, etc.).

Once a coupon is customized HTML code is provided to the local dealer for inclusion on the local dealer's website. The HTML code may be delivered automatically from the System Server for download by the local dealer immediately upon completion of the customized coupon, or via any alternative method now known or hereinafter developed. Once included on the local dealer's website, the HTML code provides/creates an online form on the website (or a link to a separate web page on which the form is located) that allows consumers visiting the website to request/obtain the coupon.

A consumer visits the local dealer's website and selects the coupon that the consumer would like to receive. The consumer is prompted to enter the consumers mobile telephone number into the online form. When the phone number is submitted, that information is provided (such as through a data connection from the dealer's website to the System Server) to the System Server for use in generating and delivering a coupon to the consumer. The System Server delivers a binary SMS message with an encoded identifier of the coupon that was designed by the local dealer and stored in a database (Offer DB) on the System Server. The consumer's mobile device (cell phone, PDA, IPhone, etc.) receives the SMS through a mobile application such as a proprietary MIDlet or other software application that has been pre-installed on the consumer's device by the consumer for receiving, storing, displaying and redeeming coupons. Upon receiving and identifying the SMS, the mobile application generates a request to the consumer to confirm whether the coupon is to be accepted. If the consumer confirms that the coupon is to be accepted, the mobile application uses the encoded identifier to request the coupon from the server.

In a preferred embodiment, the server receives information regarding the optimal display resolution of the mobile device for which the coupon is being requested. This information is provided to the server by the mobile application running on the mobile device. The server utilizes the information to resize the coupon based upon the optimal display resolution of the mobile device. The coupon is then sent by the server to the mobile device (such as through SMS or other means of data transfer from the server to the mobile device now known or hereinafter developed) and is stored in the device's internal memory for later retrieval (i.e. in an electronic wallet—storage location or folder—in the consumer's mobile device). The consumer then visits the dealer's store, selects products and/or services and approaches a POS (point of sale) terminal for checkout. The POS terminal includes software, firmware, or an other suitable application as well as appropriate hardware and/or network connectivity to allow the POS to communicate with the system server and/or offer/redemption databases to obtain appropriate information to complete a purchase transaction utilizing the coupon.

The consumer accesses the consumer's mobile wallet to provide the coupons to the POS. In one preferred embodiment, the consumer's mobile device is capable of Near Field Communication (NFC), and the POS terminal includes an NFC reader. The consumer accesses the consumer electronic wallet through the mobile application and chooses to redeem one or more coupons, the mobile application directs the consumer to touch the NFC enabled mobile device to the NFC reader of the POS terminal. Upon contact the mobile device sends the coupon identifier to the POS terminal and the POS terminal queries the System Server for validity information, offer calculations, product SKU and redemption status (and any other information) for the coupon. The POS then utilizes that information to apply the discount and notifies the server of the redemption, provides redemption data to the system server for storage in the redemption database (i.e. data regarding the specific or unique coupon used by a specific consumer, profiling information regarding the residence, sex, age, other items purchased and other data about the consumer that utilized the coupon, location of coupon usage, etc.) and the consumer transaction is completed.

In other preferred embodiments, a NFC enabled device is not utilized. In one such embodiment, the coupon sent by the server to the mobile device includes a bar code for the coupon that is displayed on the mobile device by the mobile application for scanning by a bar code scanner at the POS terminal. In the embodiment, the consumer accesses the mobile wallet and completes the transaction in much the same way and the NFC embodiment described above, the main difference being that rather than touching the mobile device to an NFC reader, the consumer allows the mobile device display (which is displaying the bar code) to be scanned by a bar code scanner. The POS then completes the transaction in the manner described above.

In still another embodiment of the instant invention, the coupon redemption from the mobile device to the POS terminal takes place “over air”. In this embodiment, the consumer's mobile device phone number (or other identifier) is entered into the POS terminal. The mobile application on the mobile device uses the mobile devices mobile network connection to access a redemption network brokerage hub. The POS terminal also accesses the redemption network brokerage hub of the System Server and requests the System server to locate the specific identified mobile device that is also accessing the hub. The System Server hub then connects the mobile device to the POS to allow the mobile device to transmit the coupon data to the POS. The coupon data transmitted includes the coupon identifier information to allow the unique coupon information to be accessed from the System Server database. In addition, the coupon data may also include the fully qualified domain name (FQDN), or other server identifier/locator, for the System Server to allow the POS to access the proper system server in which the coupon information is stored. This is particularly useful when a single POS is used to access coupon information from multiple different severs, such as multiple servers for multiple different product manufacturers whose products are all sold by a single merchant. It will be appreciated that a FQDN may be utilized in connection with any of the embodiments discussed herein (i.e. the NFC redemption or the bar code redemption embodiments).

Although in all of the embodiments discussed above, the encoded identifier (or other coupon information) for a coupon is provided to a POS terminal electronically, it will be appreciated that in alternative embodiments, such coupon information is provided to the POS terminal by manually entering said encoded identifier into an input device, such as a keyboard of said POS terminal. In one such embodiment, the consumer accesses the mobile wallet to obtain the encoded identifier, such as a series of letters or numbers. The consumer, or a POS attendant, then keys the identifier into the POS keyboard and the POS completes the transaction in the manner described above.

As is discussed above, in preferred embodiments of the instant invention the System Server sends coupon information to the mobile application of a consumer's mobile device through SMS. In a preferred embodiment the System Server sends the SMS message through an SMS brokerage service that is accessed by the System Server. In an alternative embodiment, the System Server is connected to GMS modem banks that send the SMS to the consumer's mobile device.

In a preferred embodiment, in which the consumer's mobile device includes sensors for determining the orientation of the mobile device screen (such as an Apple IPhone in which the screen may automatically rotate from portrait to landscape), the mobile application on the mobile device will access the System Server to obtain the new size information for the coupon when the device is rotated. In a preferred embodiment, both sizes, portrait and landscape, are cached in the mobile device memory until the coupon is deleted, redeemed or expires pursuant to brand rules or other expiration data stored in the electronic coupon data on the mobile device. This allows the mobile application to quickly display the coupon on the mobile device when it is accessed by the consumer.

As is discussed above, in some preferred embodiments of the instant invention, the POS only receives minimal data regarding the coupon from the consumers mobile device, such as a FQDN and a unique identifier for the coupon. This information allows the POS to query the System Server to receive more details about the coupon while minimizing the necessary connection for data transmission between the POS and the mobile device. In a preferred embodiment, the System Server sends a display image of the coupon that is specifically sized for the display of the POS terminal to allow the POS operator to view the coupon.

The instant invention allows coupons to be individualized in any manner desired by the coupon distributor. A separate identifier may be created and stored in a redemption database for each individual consumer that requests a coupon. In this manner, a manufacturer can ensure that only the consumer to whom the coupon was sent may utilize the coupon. In addition, the coupon distributor may track redemption information for a coupon. For example, a manufacturer may create a coupon template that is intend to be viral, that allows consumers to pass coupons on from their mobile devices to the mobile devices of other consumers. When a coupon is passed from one consumer to another, a new copy of the coupon is actually created by the system server, with a new unique ID that is unique to the mobile device to which the coupon has been forwarded. In such case, the consumer who originally obtained the coupon will use the mobile application to forward the coupon to another mobile device. The phone number of the new mobile device is entered into the mobile application and the mobile application communicates with the System Server to request that the System Server transmit a copy of the coupon to the new device. The System Server stores information regarding the new coupon and new mobile device in its redemption database, as well as information regarding the original consumer that requested and/or forwarded the coupon. Information regarding coupon redemption, transfers, and the like may be a very valuable tool for merchant and manufacturer advertisement campaigns. A merchant may choose to track when a particular consumer forwards a coupon to another consumer and provide reward points or some other incentive for the consumer to spread coupons to other consumers. A manufacturer/merchant might even provide specific rewards or reward levels to consumers that give coupons to other consumers when those coupons are redeemed. The merchant can even provide various levels of rewards when coupons are passed on to multiple consumers after the initial forwarding by a first consumer (i.e. a pyramid or tree of transfers or redemptions that originates from the original consumer).

The system of the instant invention provides virtually unlimited control and tracking of coupons by coupon distributors, because every time a coupon is transferred from one mobile device to another the System Server is accessed to complete the transfer.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 shows a schematic of a system of an embodiment of the instant invention.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

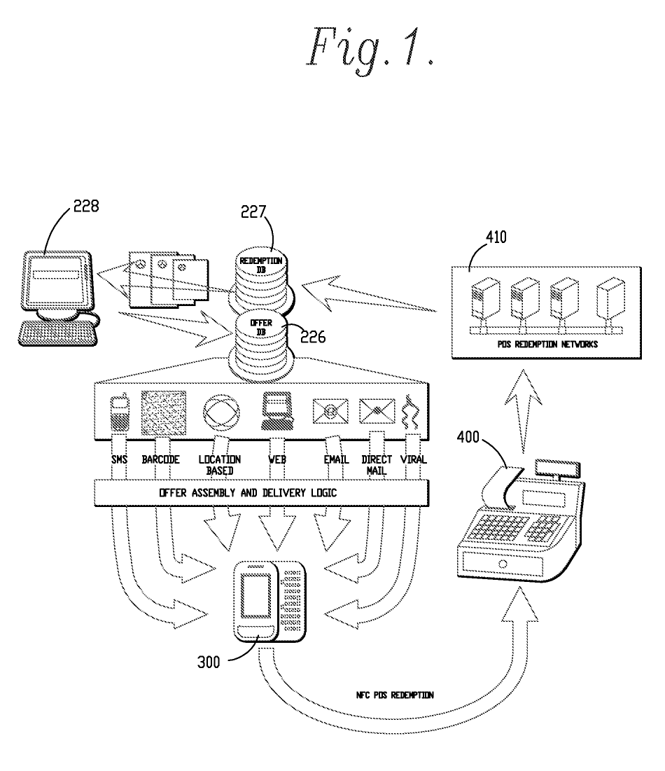

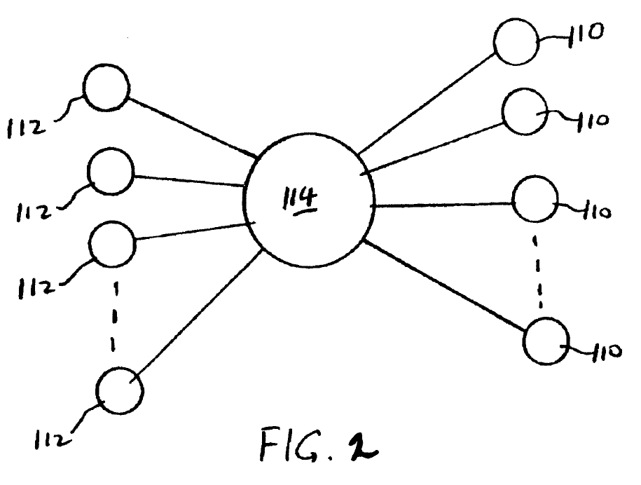

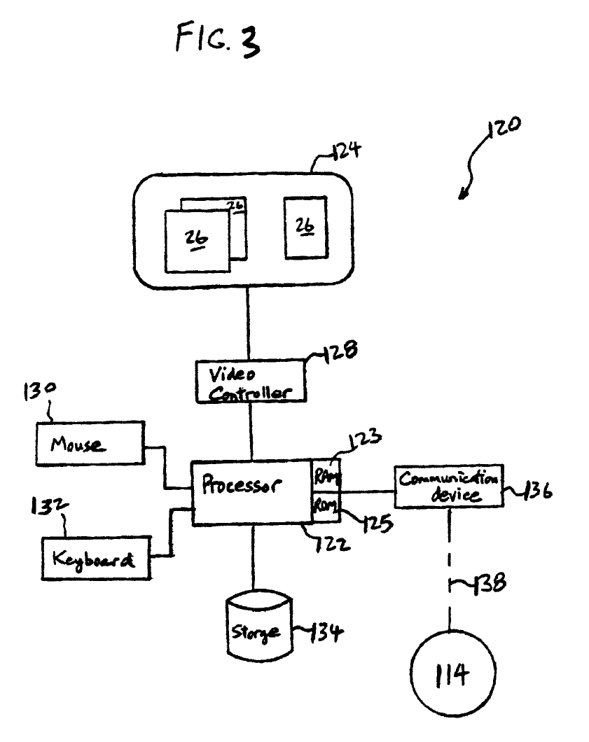

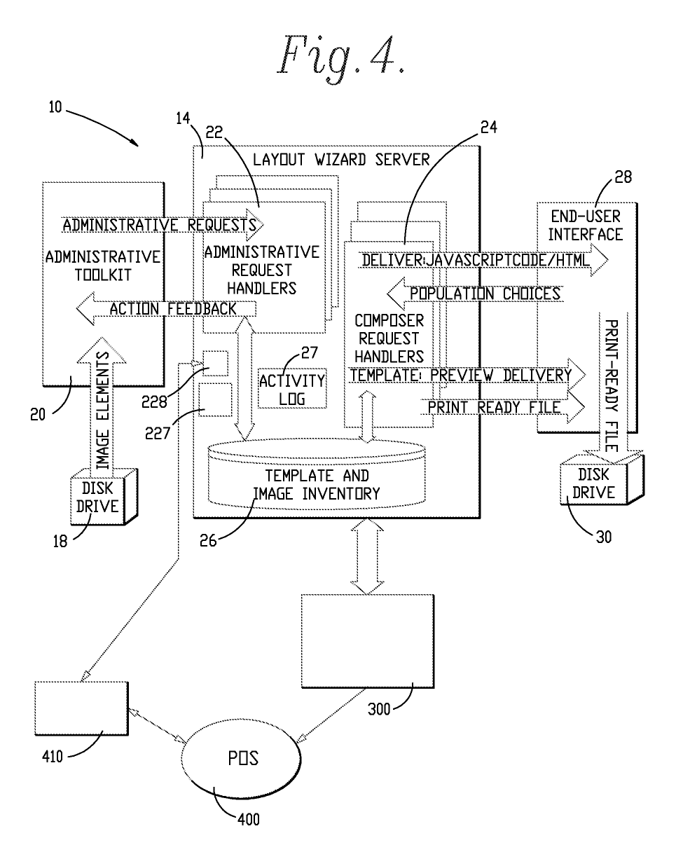

Referring to FIG. 1 a schematic of a system of an embodiment of the instant invention. In the system shown in FIG. 1 a manufacturer or other coupon distributor creates and designs a coupon by accessing the System Server through a client machine 228. Coupon information is stored in one or more databases on the System Server, such as an Offer DB 226 and/or a Redemption database 227. In the embodiment shown in FIG. 1, the Offer Database includes information for a coupon template, SKU information, discount, etc. The Redemption database includes information regarding a specific coupon that has been created and sent to a consumer, such as the unique coupon ID, consumer phone number, etc. The Offer database may be accessed to provide coupons to consumers through a variety of sources and in a number of different formats, including through a mobile device SMS connection/transfer, bar code, specific location, internet/web connection, email, direct mail, or viral (device to device—forwarding coupons from one consumer to another). Offer assembly and delivery logic (such as logic of the System Server) is utilized to input the coupon, through whatever format, to a consumer's mobile device 300. In the embodiment shown, the mobile device 300 is an NFC device, and coupon information is transmitted to the POS terminal 400 through an NFC communication. Nevertheless, it will be appreciated that other manners of transfer (as are discussed above) may be utilized without departing from the spirit and scope of the instant invention. The POS terminal utilizes the coupon information and accesses redemption networks 410 to obtain additional information and/or to verify information, and provides redemption information to the System Server to update the Redemption database 227.

Referring to FIGS. 2 through 4, an embodiment of the instant invention, in which a template coupon is created utilizing a layout wizard of the type described in the '591 Patent. In the embodiment disclosed herein, the system server of the layout wizard includes the offer and assembly and delivery logic of the system server discussed above with respect to FIG. 1, and accesses the redemption and offer databases (226 and 227), and communicates with POS 400 through redemptions networks 410. Nevertheless, it will be appreciated that the functionality of the layout wizard system server, and of the coupon distribution system may be contained in one or more separate server (or other suitable hardware and/or software/application) components. Furthermore, it will be appreciated that although shown as separate databases, the redemption and offer databases may be a single database and may further be combined with one or more databases of the layout wizard system server. It will still further be appreciated that any database may be located remote from any server or other hardware component that accesses such database.

The present invention is directed to publishing, distribution and/or tracking of content, such as graphics and textual material. To facilitate an understanding of the principles and features of the present invention, they are explained herein in connection with FIGS. 2 through 4 with reference to its deployments and implementations in illustrative embodiments. By way of example and not limitation, the present invention is described herein-below in reference to examples of deployments and implementations for advertisements and, more particularly, composing and publishing/distributing coupons via an information exchange environment and, more particularly, in the Internet environment.

The present invention can find utility in a variety of implementations without departing from the scope and spirit of the invention, as will be apparent from an understanding of the principles that underlie the invention. It is understood that the publishing concept of the present invention may be applied to publishing of materials of other nature, in any format or on any media, whether in an information network environment or otherwise. For example, the publishing concept of the present invention may be applied to publications such as coupons, advertisements, web pages, brochures, signs, posters, booklets, books, pamphlets, door hangers, billboards, overlays, iron-ons, stickers, cards, newsprint, binding, etc., in the form of prints, digital files, audio, audio files, video, video file, etc., which one party may wish to facilitate and control the scope and manner of the use of its contents for such publications. The content material composed for publication includes graphics that may include textual components, whether represented graphically or in character fonts. Hence, reference to graphics herein may include texts as well.

The invention may be implemented on any platform involving, without limitation, distributed information exchange networks, such as public and private computer networks (e.g., Internet, Intranet, WAN, LAN, etc.), value-added networks, communications networks (e.g., wired or wireless networks), broadcast networks, and a homogeneous or heterogeneous combination of such networks. As will be appreciated by those skilled in the art, the networks include both hardware and software and can be viewed as either, or both, according to which description is most helpful for a particular purpose. For example, the network can be described as a set of hardware nodes that can be interconnected by a communications facility, or alternatively, as the communications facility, or alternatively, as the communications facility itself with or without the nodes. It will be further appreciated that the line between hardware and software is not always sharp, it being understood by those skilled in the art that such networks and communications facility involve both software and hardware aspects.

A method or process is here, and generally, conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Useful devices for performing the operations of the present invention include, but are not limited to, general or specific purpose digital processing and/or computing devices, which devices may be standalone devices or part of a larger system. The devices may be selectively activated or reconfigured by a program, routine and/or a sequence of instructions and/or logic stored in the devices. In short, use of the methods described and suggested herein is not limited to a particular processing configuration. Prior to discussing details of the inventive aspects of the present invention, it is helpful to discuss one example of a network environment in which the present invention may be implemented.

The Internet is an example of an information exchange network including a computer network in which the present invention may be implemented, as illustrated schematically in FIG. 2. Many servers 110 are connected to many clients 112 via Internet network 114, which comprises a large number of connected information networks that act as a coordinated whole. Details of various hardware and software components comprising the Internet network 114 are not shown (such as servers, routers, gateways, etc.) as they are well known in the art. Further, it is understood that access to the Internet by the servers 110 and clients 112 may be via suitable transmission medium, such as coaxial cable, telephone wire, wireless RF links, or the like. Communication between the servers 110 and the clients 112 takes place by means of an established protocol. As will be noted below, the system of the present invention may be configured in or as one of the servers 110, which may be accessed by users and content providers via clients 112.

Turning now to FIG. 3, there is schematically illustrated one embodiment of a computer system 120 which may be configured as the client 112 for navigating the Internet. The computer system 120 communicates with the Internet network 114. The computer system 120 includes a processor 122, internal random-access memory (“RAM”) 123 and read-only memory (“ROM”) 125, and a data bus architecture for coupling the processor 122 to various internal and external components. The computer system 120 further includes a communication device 36 which, in turn, is coupled to a communication channel 38 for effecting communication with the Internet network 114. A mass storage device 34, such as a hard disk drive or floppy disk drive of CD-ROM drive, is coupled to the processor 122 for storing utility and application software (including a suitable web browser for navigating the Internet) and other data. The application software is executed or performed by the processor 122.

User actuatable input devices are also coupled to the processor 122, including a cursor positioning device 130 and a keyboard 132 in accordance with the present invention. The cursor positioning device 310 is representative of any number of input devices that produce signals corresponding to a cursor location on the display 124, and may include by way of example, a mouse, a trackball, an electronic pen, or a touch-pad, which may be an integral part of the keyboard 132. A display 124 is coupled to the processor 122 through a video controller 128. The video controller 128 coordinates the presentation of information on the display 124 in one or more windows 126. Generally, the windows 126 are scalable, thus permitting a user to define the size and location of a particular window 126 on the display 1124.

The server 110 could also have similar components as the computer system 120 depicted in FIG. 3. The program configuration of the client 112 and server 110 would be apparent given the disclosure of the desired functions of the client 112 and server 110 disclosed hereinbelow. Basic online processes are well known in the art.

Referring to FIG. 4, the publication layout and distribution system 10 generally consists of several inter-operative components, namely, the Administrative Toolkit 20, the System Server 14, and the End-User Interface 28, all of which are discussed in further detail in the '591 Patent. The Administrative Toolkit 20 is the interface through which the content providers will provide company logos, trademarks, graphics, coupon offer requirements/guidelines, and other relevant advertising/promotional materials. The System Server 14 is the central unit that bridges the Administrative Toolkit 20 with the End-User Interface 28. The System Server 14 will actually store the various manufacturers' advertising materials and coupons in offer database 226 as well as keep track of all of the merchants and dealers (the end-users) who have access to the End-User Interface 28 (a client of the system server), as well as keep track of coupon redemption information in redemption database 227. In addition, the System Server functions in the same manner as the system server discussed above with respect to FIG. 1 to distribute and track coupons and redemptions. As such the System Server 14 will act as the brain of the overall publication layout and coupon distribution system 10.

System server 14 includes (or is otherwise operably connected with) offer database 226 and redemption database 227, and is also connected via an information exchange network (including, but not limited to redemption networks 410) with POS 400 and the consumer's mobile device 300, both of which act as clients of system server 14.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A method of creating and/or distributing promotional materials, the method comprising the steps of:
creating by a brand originator a promotional material item template via a computer-implemented system for laying out a publication;
storing said template in a template database accessible by said system;
accessing said template in said template database by a merchant to customize a promotional material item based upon said template, said promotional material item including a product or service identifier to which said promotional material item relates, and said promotional material item including an encoded identifier for said promotional material item;
storing said promotional material item in an offer database accessible by said system;
providing an online form for consumers to request said promotional material item;
requesting said promotional material item by a consumer, said requesting step including the step of submitting a mobile telephone number for a mobile device of said consumer to a system server, said system server having access to said offer database;
delivering an SMS message to said mobile device by said system server, said message including said encoded identifier for said promotional material item;
receiving said SMS message by a mobile application on said mobile device;
confirming by said consumer through said mobile application that said promotional material item is desired;
requesting by said mobile application said promotional material item from said system server;
providing to said system server by said mobile application information regarding optimal display resolution for said mobile device;
sizing by said system server said promotional material item based upon said optimal display resolution;
distributing a copy of said promotional material item to said mobile device after said sizing step; and
storing said copy of said promotional material item in a storage location of said mobile device.

2. The method as claimed in claim 1 further comprising the step of redeeming electronically said promotional material item.

3. The method as claimed in claim 2 wherein said step of redeeming includes the step of providing said encoded identifier for said promotional material item to a POS terminal.

4. The method as claimed in claim 3 wherein said step of providing said encoded identifier for said promotional material item to a POS terminal is accomplished electronically.

5. The method as claimed in claim 4 wherein said step of providing said encoded identifier for said promotional material item to a POS terminal is accomplished using Near Field Communication between said POS terminal and said mobile device.

6. The method as claimed in claim 4 wherein said step of providing said encoded identifier for said promotional material item to a POS terminal is accomplished using a bar code generated on a display screen of said mobile device and scanned by a bar code scanner associated with said POS device.

7. The method as claimed in claim 4 wherein said step of providing said encoded identifier for said promotional material item to a POS terminal is accomplished over air.

8. The method as claimed in claim 3 wherein said step of providing said encoded identifier for said promotional material item to a POS terminal is accomplished by manually entering said encoded identifier into an input device of said POS terminal.

9. The method as claimed in claim 3 wherein said step of redeeming includes the step of querying said system server by said POS to obtain additional information regarding said promotional material item.

10. The method as claimed in claim 9 further comprising the step of sending by said system server a copy of said promotional material item sized to the optimal display resolution of said POS terminal.

11. The method as claimed in claim 1 further comprising the steps of:
determining a change in orientation of said mobile device;
providing to said system server by said mobile application information regarding optimal display resolution for the new orientation of said mobile device;
sizing by said system server said promotional material item based upon said optimal display resolution for the new orientation of said mobile device;
distributing a copy of said promotional material item to said mobile device after said sizing step for the new orientation of said mobile device; and
storing said copy of said promotional material item after said sizing step for the new orientation of said mobile device in said storage location of said mobile device.

12. The method as claimed in claim 11 wherein multiple copies of said promotional material item of different sizes are stored in said storage location of said mobile device.

13. The method as claimed in claim 1 wherein said step of providing information regarding optimal display resolution for said mobile device include display resolution for multiple different orientations of said mobile device, and wherein said steps of distributing and storing said copy of said promotional material item includes multiple copies of said promotional material item of different sizes associated with each orientation.

14. The method as claimed in claim 1 wherein said copy of said promotional material item includes a unique identifier associated with said mobile device.

15. The method as claimed in claim 14 further comprising the step of storing said unique identifier associated with said mobile device in a redemption database accessible by said system server.

16. The method as claimed in claim 15 further comprising the step of storing information regarding promotional material item redemptions and/or transfers in said redemption database.

17. The method as claimed in claim 1 wherein said promotional material item is a coupon for a product or service.

18. The method as claimed in claim 1 further comprising the step of forwarding said promotional material item from said mobile device to an other mobile device, said forwarding step including the steps of:
submitting a mobile telephone number for said other mobile device to a system server; and
distributing a copy of said promotional material item to said other mobile device.

19. A method of creating and/or distributing promotional materials, the method comprising the steps of:
creating by a distributor a promotional material item and storing said item in an offer database accessible by a system server;
requesting said promotional material item by a consumer, said requesting step including the step of providing information regarding an electronic device associated with said consumer that is capable of receiving said promotional material item;
distributing a copy of said promotional material item to said electronic device, said promotional material item including a product or service identifier to which said promotional material item relates, and said copy of said promotional material item including a unique identifier for said copy of said promotional material item;
storing information regarding said copy of said promotional material item in a redemption database accessible by said system server.

20. The method as claimed in claim 19 further comprising the step of redeeming said promotional material item via a POS terminal that communicates with said system server.

21. The method as claimed in claim 19 wherein said mobile device is a device of a person other than said consumer.
